(19) United States
(12) Patent Application Publication
(10) Pub. No.: US 2016/0277217 A1
(43) Pub. Date: Sep. 22, 2016

(54) HOME CONTROL GATEWAY AND HOME CONTROL METHOD THEREOF

(71) Applicant: proeasy network solutions co., LTD., Hsinchu County (TW)

(72) Inventor: Hsing-Hung Lu, Hsinchu County (TW)

(21) Appl. No.: 14/709,498

(22) Filed: May 12, 2015

(30) Foreign Application Priority Data
Mar. 18, 2015 (TW) 104108625

(51) Int. Cl. H04L 12/66; H04L 29/08; H04W 4/14; H04L 12/28

(52) U.S. Cl. CPC H04L 12/66; H04L 12/2816; H04L 67/1097; H04L 67/06; H04W 4/14

(57) ABSTRACT

A home control gateway and a home control method are provided. The home control gateway includes a microprocessor unit, a first communication circuit, a second communication circuit, and a gateway management module. The first communication circuit is configured for connecting to a network, and connects to a cloud storage device via the network. The cloud storage device provides a storage space, and a user may use a wireless communication electronic device to transfer a file including home control instructions to the storage space. The second communication circuit is configured for connecting to a mobile phone network. The gateway management module is configured for downloading the file from the storage space, analyzing the file for obtaining the home control instructions, and changing the status of home control switches based on the home control instructions.

### CROSS-REFERENCE TO RELATED APPLICATION

This application claims the priority benefit of Taiwan application serial no. 104108625, filed on Mar. 18, 2015. The entirety of the above-mentioned patent application is hereby incorporated by reference herein and made a part of this specification.

### BACKGROUND

1. Field of the Invention

The invention is directed to a home control technique and more particularly, to a home control gateway and a home control method.

2. Description of Related Art

A home automation control system generally utilizes automated equipment in combination with computer software technology and applications to integrate household equipment, such as televisions, electric rice cooker, air conditioners, refrigerators, gas switches, alarm systems, security systems, surveillance systems, so as to improve home comfort and home safety. The home automation control system usually includes a control system and a control host, such that a user may issue control commands via the control system to drive various apparatuses by using the host system. In addition, a user can use the network connecting function of a mobile phone or a notebook computer to connect to the Internet to remotely control various home apparatuses, start up a security mechanism or monitor home circumstance through various wireless communication transmission technologies (e.g., GPRS, WiFi, WiMAX, 3G or 4G) when the user is in business trip, on vacation or traveling.

However, the remote control provides not only flexibility and convenience but also security issues, e.g., an issue of verification of the user's identity (ID). In general, only after the user's ID is verified through an authentication mechanism, the control host would assign a control right to the user and allow the user to achieve the purpose of the remote control. A common method to the above is to provide a web address by a remote home control system host, so that the user may enter a user name and a password correctly through the web address in order to obtain the control right of the remote home control system host after the authentication is passed. However, a user may forget the user name and the password, or the user name and the password may even probably be stolen. Therefore, how to provide a convenient, safe and easy way for the user to conveniently and securely perform the remote control has become one of the major subjects in the industry.

### SUMMARY

The invention provides a home control gateway and a home control method, in which a user stores a home control instruction as a file in a cloud storage device, and the home control gateway downloads the file from the cloud storage device, analyzes the home control instruction in the file to change a state of a home control switch. In this way, the user can issue a plurality of home control instructions at one time to control different home control switches and control different home control gateways.

According to an exemplary embodiment of the invention, a home control gateway including a microprocessor unit, a first communication circuit, a second communication circuit and a gateway management module is provided. The first communication circuit is coupled to the microprocessor unit and configured to connect to a network and connect to a cloud storage device through the network. The cloud storage device provides a storage space. A wireless communication electronic device transmits a file to the storage space, and the file includes at least one home control instruction. The second communication circuit is coupled to microprocessor unit and configured to connect to a mobile phone network. The gateway management module is coupled to the microprocessor unit. The gateway management module downloads the file from the storage space, analyzes the file to obtain at least one home control instruction and changes a state of a home control switch according to the at least one home control instruction.

In an exemplary embodiment of the invention, the storage space is at least divided into a first input storage space and a first output storage space configured for the wireless communication electronic device. The wireless communication electronic device transmits the file to the first output storage space. The second communication circuit receives an incoming call signal from the wireless communication electronic device and identifies an incoming phone number according to the incoming call signal. If the incoming phone number is identical to a pre-stored phone number stored in the gateway management module, the gateway management module downloads the file from the first output storage space.

In an exemplary embodiment of the invention, the storage space is at least divided into a second input storage space and a second output storage space configured for the gateway management module. The wireless communication electronic device transmits the file to the second output storage space. The gateway management module checks whether there is any file in the second input storage space per a first predetermined time period. If the file is in the second input storage space, the gateway management module downloads the file from the second input storage space.

In an exemplary embodiment of the invention, the storage space is at least divided into a second input storage space and a second output storage space configured for the gateway management module. And, the wireless communication electronic device transmits the file to the second output storage space. The first communication circuit receives a first file change notification from the cloud storage device, and the gateway management module downloads the file from the second input storage space in response to the first file change notification.

In an exemplary embodiment of the invention, the storage space is at least divided into a second input storage space and a second output storage space configured for the gateway management module. And, the wireless communication electronic device transmits the file to the second output storage space. The second communication circuit receives an incoming call signal from the wireless communication electronic device and identifies an incoming phone number according to the incoming call signal. If the incoming phone number is identical to a pre-stored phone number stored in the gateway management module, the gateway management module downloads the file from the second input storage space.

In an exemplary embodiment of the invention, the gateway management module stores at least one response file corresponding to the at least one home control instruction in the second output storage space, and the at least one response file includes an instruction execution state. The gateway management module transmits a signal to the wireless communication electronic device through the mobile phone network by using the second communication circuit. The wireless communication electronic device downloads the at least one response file from the second output storage space according to the signal to obtain the instruction execution state.

In an exemplary embodiment of the invention, the gateway management module stores at least one response file corresponding to the at least one home control instruction in the first input storage space, and the at least one response file includes an instruction execution state. The gateway management module transmits a signal to the wireless communication electronic device through the mobile phone network by using the second communication circuit. The wireless communication electronic device downloads the at least one response file from the first input storage space according to the signal to obtain the instruction execution state.

In an exemplary embodiment of the invention, the gateway management module stores at least one response file corresponding to the at least one home control instruction in the first input storage space, and the at least one response file includes an instruction execution state. The wireless communication electronic device checks whether there is any response file in the first input storage space per a second predetermined time period. If at least one response file is in the first input storage space, the wireless communication electronic device downloads the at least one response file from the first input storage space to obtain the instruction execution state.

In an exemplary embodiment of the invention, the gateway management module stores at least one response file corresponding to the at least one home control instruction in the first input storage space, and the at least one response file includes an instruction execution state. The wireless communication electronic device receives a second file change notification from the cloud storage device and downloads the response files from the first input storage space to obtain the instruction execution state in response to second file change notification.

In an exemplary embodiment of the invention, the incoming call signal is a voice communication signal or a short message service (SMS) signal.

In an exemplary embodiment of the invention, the signal transmitted from the gateway management module through the mobile phone network by using the second communication circuit is a voice communication signal or an SMS signal.

In an exemplary embodiment of the invention, the file includes a gateway number, a function number and an operation instruction.

According to an exemplary embodiment of the invention, a home control method for a home control gateway is provided. The home control method includes: connecting to a network and connecting to a cloud storage device through the network, wherein the cloud storage device provides a storage space, and the wireless communication electronic device transmits a file including at least one home control instruction to the storage space. The home control method also includes downloading the file from the storage space. The home control method further includes analyzing the file to obtain the at least one home control instruction and changing a state of a home control switch according to the at least one home control instruction.

In an exemplary embodiment of the invention, the home control method further includes connecting to a mobile phone network, wherein the storage space is at least divided into a first input storage space and a first output storage space configured for the wireless communication electronic device, the wireless communication electronic device transmits the file to the first output storage space, and the step of downloading the file from the storage space includes: receiving an incoming call signal from the wireless communication electronic device through the mobile phone network and identifying an incoming phone number according to the incoming call signal; and if the incoming phone number is identical to a pre-stored phone number, downloading the file from the first output storage space.

In an exemplary embodiment of the invention, the storage space is at least divided into a second input storage space and a second output storage space configured for the home control gateway, the wireless communication electronic device transmits the file to the second output storage space, and the step of downloading the file from the storage space includes: checking whether there is any file in the second input storage space per a first predetermined time period; and if the file is in the second input storage space, downloading the file from the second input storage space.

In an exemplary embodiment of the invention, the storage space is at least divided into a second input storage space and a second output storage space configured for the home control gateway, the wireless communication electronic device transmits the file to the second output storage space, and the step of downloading the file from the storage space includes receiving a first file change notification from the cloud storage device and downloading the file from the second input storage space in response to the first file change notification.

In an exemplary embodiment of the invention, the home control method further includes connecting to a mobile phone network. The storage space is at least divided into a second input storage space and a second output storage space configured for the home control gateway, the wireless communication electronic device transmits the file to the second output storage space, and the step of downloading the file from the storage space includes receiving an incoming call signal from the wireless communication electronic device through the mobile phone network and identifying an incoming phone number according to the incoming call signal; and if the incoming phone number is identical to a pre-stored phone number, downloading the file from the second input storage space.

In an exemplary embodiment of the invention, the home control method further includes storing at least one response file corresponding to the at least one home control instruction in the second output storage space; and transmitting a signal to the wireless communication electronic device through the mobile phone network. The at least one response file includes an instruction execution state, and the wireless communication electronic device downloads the at least one response file from the second output storage space according to the signal to obtain the instruction execution state.

In an exemplary embodiment of the invention, the home control method further includes storing at least one response file corresponding to the at least one home control instruction in the first input storage space; and transmitting a signal to the wireless communication electronic device through the mobile phone network. The at least one response file includes an instruction execution state, and the wireless communication electronic device downloads the at least one response file from the first input storage space according to the signal to obtain the instruction execution state.

In an exemplary embodiment of the invention, the home control method further includes: storing at least one response file corresponding to the at least one home control instruction in the first input storage space, wherein the at least one response file includes an instruction execution state, checking whether there is any response file in the first input storage space per a second predetermined time period by the wireless communication electronic device and if the at least one response file is in the first input storage space, downloading the response file from the first input storage space to obtain the instruction execution state by the wireless communication electronic device.

In an exemplary embodiment of the invention, the home control method further includes storing at least one response file corresponding to the at least one home control instruction in the first input storage space, wherein the at least one response file includes an instruction execution state; and receiving a second file change notification from the cloud storage device and downloading the at least one response file from the first input storage space to obtain the instruction execution state in response to the second file change notification by the wireless communication electronic device.

Based on the above, in the home control gateway and the home control method of the invention, the wireless communication electronic device uploads the file including the home control instructions to the storage space in the cloud storage device, and the home control gateway downloads the file from the storage space, analyzes the file to obtain the home control instructions, and change the home control switches according to the home control instructions, so as to manage the home control functions conveniently.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating remote home control according to an exemplary embodiment of the invention.

FIG. 2 is a block diagram illustrating a home control gateway according to an exemplary embodiment of the invention.

FIG. 3 is a schematic diagram illustrating an instruction table of home control instructions according to an exemplary embodiment of the invention.

FIG. 4 is a schematic diagram illustrating a storage space according to the first exemplary embodiment of the invention.

FIG. 5 is a schematic diagram illustrating a storage space according to the second exemplary embodiment of the invention.

FIG. 6 is a flowchart illustrating a home control method according to an exemplary embodiment of the invention.

### DESCRIPTION OF EMBODIMENTS

With the development of the network technologies, if a safe remote control manner can be provided to a user to conveniently manage a home control gateway, an automation home control system can be operated easily. Accordingly, the prevent invention is developed according to this conception.

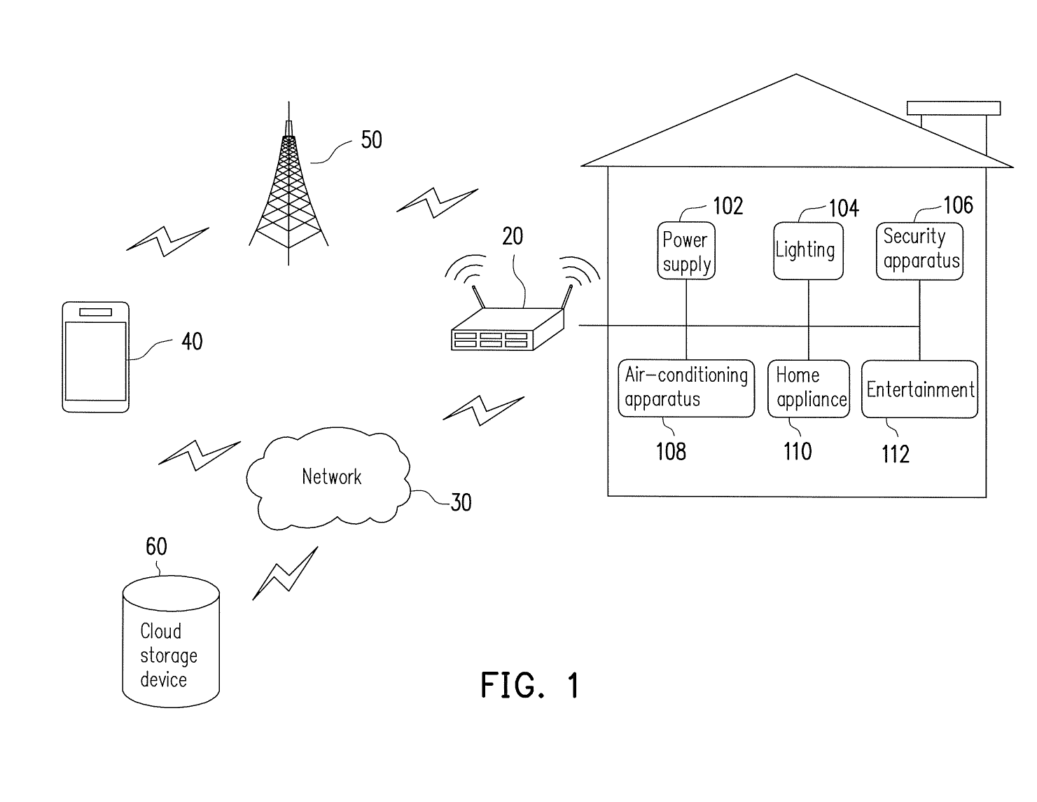

FIG. 1 is a schematic diagram illustrating remote home control according to an exemplary embodiment of the invention.

With reference to FIG. 1, a remote home control environment commonly includes home equipment, a home control gateway 20, a network 30, a wireless communication electronic device 40, a mobile phone network 50 and a cloud storage device 60.

The home equipment includes a power supply 102, a lighting apparatus 104, a security apparatus 106, an air-conditioning apparatus 108, a home appliance 110 and an entertainment apparatus 112. However, it should be understood that, the home equipment is not limited to those listed above, and the home equipment also construes no limitations to the invention. For example, the power supply 102, the lighting apparatus 104, the security apparatus 106, the air-conditioning apparatus 108, the home appliance 110 and the entertainment apparatus 112 respectively have control chips or control circuits for receiving home control instructions from the home control gateway 20 and performing corresponding functions and/or operations according to the home control instructions.

The home control gateway 20 has a plurality of home control switches, where each home control switch is corresponding to a home control function of the home apparatus. Additionally, the home control gateway 20 has one or more communication channels, and a user may communicate with the home control gateway 20 for remote control through the communication channels.

The network 30 is a communication network established according to an Internet protocol (IP) transmission standard, and the home control gateway 20 may communicate with other electronic devices provided with Internet connection capability through the network 30. For instance, the IP transmission standard may be the Transmission Control Protocol/Internet Protocol (TCP/IP) standard or the User Datagram Protocol/Internet Protocol (UDP/IP) standard. Additionally, in another exemplary embodiment of the invention, the network 30 may be a wireless local area network (e.g., Wi-Fi) established according to a local area network (LAN) protocol transmission standard. For instance, this LAN protocol transmission standard may be 802.11 series constituted by Institute of Electrical and Electronics Engineers (IEEE). However, the invention is not limited thereto.

The wireless communication electronic device 40 is a mobile communication equipment of a user, which includes a Subscriber Identity Module Card (SIM Card). The wireless communication electronic device 40 may be, for example, a cell phone, a personal digital assistant (PDA), a smart phone or the like, and the invention is not intent to limit the type of the wireless communication electronic device 40.

The mobile phone network 50 is a is a telecommunication service provided by a telecommunication service provider, such as Global System For Mobile Communications (GSM), Code Division Multiple Access (CDMA), Personal Handy-phone System (PHS) or the like, but the invention is not limited thereto.

The cloud storage device 60 is, for example, a computing device with a computing capability, such as a file server, a database server, a workstation or a personal computer.

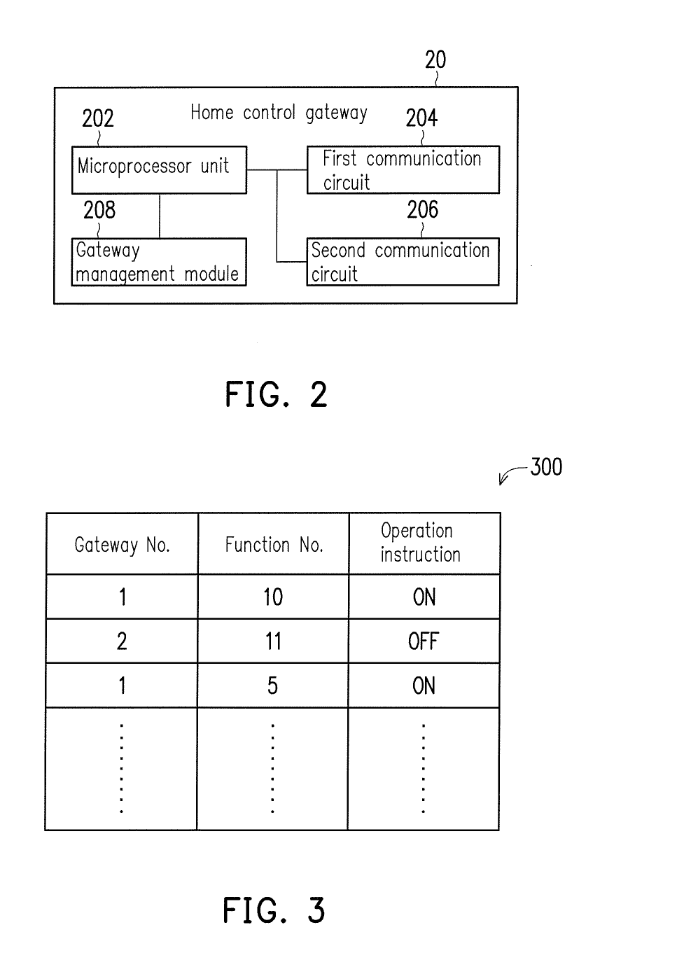

FIG. 2 is a block diagram illustrating a home control gateway according to an exemplary embodiment of the invention.

With reference to FIG. 2, the home control gateway 20 includes a microprocessor unit 202, a first communication circuit 204, a second communication circuit 206 and a gateway management module 208.

The microprocessor unit 202 is a hardware (e.g., a chipset, a processor or the like) with a computing capability and configured to control overall operation of the home control gateway 20. In the present exemplary embodiment, the microprocessor unit 202 is, for example, a central processing unit (CPU) or any other programmable microprocessor, a digital signal processor (DSP), a programmable controller, an application specific integrated circuits (ASIC), a programmable logic device (PLD) or the like.

The first communication circuit 204 is coupled to the microprocessor unit 202, and is configured to connect to the network 30 and connect to the cloud storage device 60 through the network 30. The first communication circuit 204 is operated by using a transmission standard or a protocol compatible with the local area network 30 for transferring or receiving packets through the network 30.

The second communication circuit 206 is coupled to the microprocessor unit 202 and configured to connect to the mobile phone network 50. The second communication circuit 206 is operated by using a transmission standard or a protocol compatible with the mobile phone network 50 for transferring or receiving voice signals or instant messages through the mobile phone network 50.

The gateway management module 208 is coupled to the microprocessor unit 202. The function of the gateway management module 208 is implemented in a form of a circuit; however, the invention is not limited thereto. For instance, the function of the gateway management module 206 may also be implemented in a form of program codes. And, when the home control gateway 20 is powered on, the microprocessor unit 202 may operate the program codes to perform the function of the gateway management module 206.

In the present exemplary embodiment, the cloud storage device 60 is configured to provide a storage space to the user, and the user may transmit a file containing the home control instructions to the storage space through the wireless communication electronic device 40. Specially, the gateway management module 206 may download the file from the storage space of the cloud storage device 60, analyzes the file to obtain the home control instructions, and change states of home control switches according to the home control instructions.

To be specific, a home control switch is corresponding to a home control function of a home equipment. The home control instruction is configured to indicate a state of the home control switch, such that the actuation of the home control function of the home equipment connected with the home control gateway 20 is changed. It should be mentioned that the user may issue at least one home control instruction to at least one home control gateway. Namely, the user may control the home control gateway one at a time or a plurality at a time.

FIG. 3 is a schematic diagram illustrating an instruction table of home control instructions according to an exemplary embodiment of the invention. In the present exemplary embodiment, the file may contain an instruction table 300 recording the home control instructions, and the instruction table 300 may contain fields, such as a gateway number field, a function number field and an operation instruction field. A gateway number is configured to indicate a home control gateway to be controlled. A function number is configured to indicate a home control switch to be controlled. An operation instruction is configured to indicate a state of a home control switch. Additionally, in another exemplary embodiment, the instruction table 300 may contain an execution timing field. The execution timing field is configured to indicate to change a state of a home control switch at a specified time.

With reference to FIG. 3, the instruction table 300 contains a plurality of home control instructions, and the home control instructions (in a sequence from top to bottom) respectively indicate to set No. 10 home control switch (e.g., corresponding to an air conditioner switch) controlled by No. 1 home control gateway as ON, to set No. 5 home control switch (e.g., corresponding to a living room lamp switch) controlled by No. 1 home control gateway as ON and to set No. 11 home control switch (e.g., corresponding to an electric curtain switch) controlled by No. 2 home control gateway as OFF.

In detail, the file is in a text file format, for example, and may be encrypted for better security. Additionally, the cloud storage device 60 may verify an identity (ID) of a user attempting to access by checking the ID. The home control gateway 20 and the wireless communication electronic device 40 may log in the cloud storage device 60 by using the same ID and access a storage space corresponding to the ID after the ID is verified by the cloud storage device 60.

In this way, the user may control the home equipment easily and manage the home apparatuses connected with different home control gateways.

### First Exemplary Embodiment

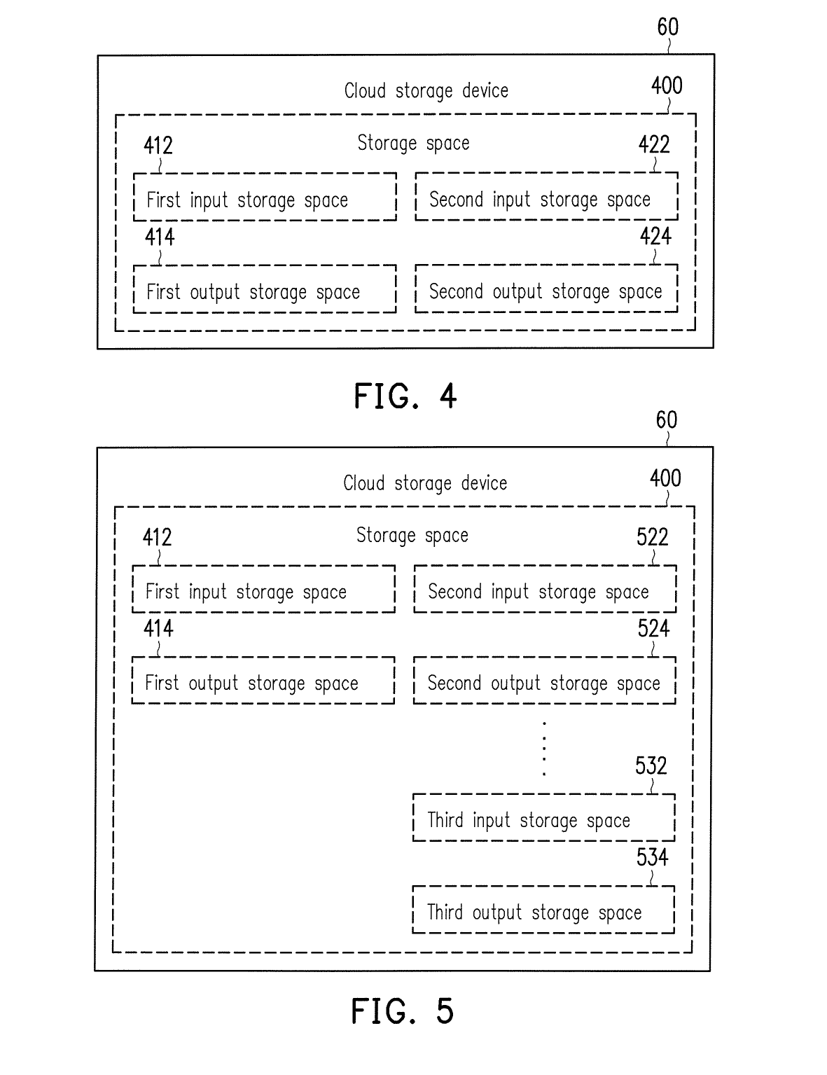

FIG. 4 is a schematic diagram illustrating a storage space according to the first exemplary embodiment of the invention. In the present exemplary embodiment, the user may instruct the home control gateway 20 to control the home equipment through the wireless communication electronic device 40.

With reference to FIG. 4, a storage space 400 of the cloud storage device 60 is divided into at least a first input storage space 412 and a first output storage space 414 configured for the wireless communication electronic device 40, and a second input storage space 422 and a second output storage space 424 configured for the home control gateway 20 (the gateway management module 208). Specifically, the cloud storage device 60 provides the user with the storage space 400, and the home control gateway 20 and the wireless communication electronic device 40 may access the storage space 400 by using the same ID which is previously set. In the present exemplary embodiment, the first input storage space 412, the first output storage space 414, the second input storage space 422 and the second output storage space 424 are, for example, folders in the storage space 400. For instance, link addresses of the first input storage space 412, the first output storage space 414, the second input storage space 422 and the second output storage space 424 may be represented by using uniform resource identifiers (URIs) and previously set in the home control gateway 20 and the wireless communication electronic device 40.

In the present exemplary embodiment, the user may transmit the file containing the home control instructions to the second input storage space 422 of the home control gateway 20 (the gateway management module 208) through the wireless communication electronic device 40 to instruct the home control gateway 20 to execute the home control instructions contained in the file.

The gateway management module 208 of the home control gateway 20 checks whether there is any file in the second input storage space 422 per a predetermined time period. If the file is in the second input storage space 422, the gateway management module 208 downloads the file from the second input storage space 422. In detail, the home control gateway 20 may set the predete tined time period and start the countdown, check whether there is any file in the second input storage space 422 when the countdown ends and reset the predetermined time period and start again the countdown if there is no file and thereby, perform the checking operation in this way periodically. In addition, the predeteiinined time period may also have a variable time length. For instance, the predetermined time period may be gradually shortened, such that the checking frequency may become more intensive. Accordingly, the home control gateway 20 may automatically receive the file containing the home control instructions of the user from the cloud storage device 60 and change the states of the home control switches according to the home control instructions.

Besides periodically checking whether there is any file in the second input storage space 422, the home control gateway 20 may also download the file containing the home control instructions according to the notification from the cloud storage device 60 in the example where the cloud storage device 60 provides a notification with respect to the change of the file. For instance, in another exemplary embodiment, when the user transmits the file containing the home control instructions to the second input storage space 422 configured for the home control gateway 20 (the gateway management module 208) through the wireless communication electronic device 4, the home control gateway 20 receives a file change notification (i.e., a first file change notification) from the cloud storage device 60 through the first communication circuit 204, and the gateway management module 208 of the home control gateway 20 downloads the file from the second input storage space 422 in response to file change notification. In detail, the file change notification from the cloud storage device 60 may indicate the change occurring in the storage space 400, and the file change notification may contain an URI of the file with the change. In this way, the home control gateway 20 may obtain the file containing the home control instructions of the user by means of the automatic notification from the cloud storage device 60 and change the states of the home control switches according to the home control instructions.

In addition to the above, in yet another exemplary embodiment, the home control gateway 20 may also download the file containing the home control instructions according to a notification from the wireless communication electronic device transmitting the file. For instance, when the user transmits the file containing the home control instructions to the second input storage space 422 configured for the home control gateway 20 (the gateway management module 208) through the wireless communication electronic device 40, the home control gateway 20 receives an incoming call signal from the wireless communication electronic device 40 through the second communication circuit 206 and identifies an incoming phone number according to the incoming call signal. If the incoming phone number is identical to a pre-stored phone number stored in the gateway management module 208 of the home control gateway 20, the gateway management module 208 downloads the file from the second input storage space 422. For instance, the incoming call signal may be a voice communication signal or a short message service (SMS) signal. In an example where the incoming call signal is a voice communication signal, the home control gateway 20 may receive the incoming call signal without answering it and identify the incoming phone number according to the incoming call signal. In an example where the incoming call signal is an SMS signal, the home control gateway 20 may analyze the SMS signal to obtain the incoming phone number. Moreover, the home control gateway 20 stores in advance a plurality of phone numbers as administrator numbers in the gateway management module 208. If the incoming phone number is identical to pre-stored phone number stored in the gateway management module 208 of the home control gateway 20, it represents that the incoming phone number is verified as an administrator number and thus, have a control authority. Thereby, the gateway management module 208 downloads the file from the second input storage space 422.

In the present exemplary embodiment, after the gateway management module 208 downloads the file from the second input storage space 422, the home control gateway 20 analyzes to obtain the home control instructions and changes the states of the states of the home control switches according to the home control instructions. To be specific, the home control gateway 20 has a predetermined gateway number, e.g., No. 1, which is set in advance. When analyzing the file, the home control gateway 20 may obtain a home control instruction with a recorded gateway number that is identical to the predetermined gateway number of the home control gateway 20 and ignore (e.g., does not obtain, or does not execute) a home control instruction with a recorded gateway number that is different from the predetermined gateway number of the home control gateway 20. For example, referring to FIG. 3, the home control gateway 20 may obtain a home control instruction with a gateway number recorded in the instruction table 300 that is identical to the predetermined gateway number 1. And, the home control gateway 20 does not execute a home control instruction a home control instruction with a gateway number recorded as a predetermined gateway number 2 (which is different from the predetermined gateway number 1) in the instruction table 300. Additionally, the home control gateway 20 may execute the obtained home control instruction to change a state of a home control switch and store an execution result as a response file, to report the execution performance to the user. The response file may contain an instruction execution state, such as whether the state of the home equipment is successfully changed and the settings after the change.

In an exemplary embodiment, the gateway management module 208 may store response files corresponding to the home control instructions in the first input storage space 412 configured for the wireless communication electronic device 40. And, the gateway management module 208 may transmit a signal to the wireless communication electronic device 40 through the mobile phone network 50 by using the second communication circuit 206, such that the wireless communication electronic device 40 may download a response file from the first input storage space 412 to obtain the instruction execution state according to the signal. Specially, the signal transmitted from the gateway management module 208 through the mobile phone network 50 by using the second communication circuit 206 may be a voice communication signal or an SMS signal. In this way, the gateway management module 208 may notify the user to receive the response file to obtain the instruction execution state through the wireless communication electronic device 40 by using a mobile communication signal after the response file is stored.

In another exemplary embodiment, the gateway management module 208 may also store the response files corresponding to the home control instructions to the first input storage space 412 configured for the wireless communication electronic device 40. And, the wireless communication electronic device 40 may check whether there is any response file in the first input storage space 412 per a predetermined time period. If there is a response file stored in the first input storage space 412, the wireless communication electronic device 40 downloads the response file from the first input storage space 412 to obtain the instruction execution state. In detail, the wireless communication electronic device 40 may set the predetermined time period, start the countdown after the transmitting the file to the first output storage space 414, check whether the response file is in the first input storage space 412 when the countdown ends, reset the predetermined time period and start again the countdown if there is no file and thereby, perform the checking operation in this way periodically. In addition, the predetermined time period may also have a variable time length. For instance, the predetermined time period may be gradually shortened, such that the checking frequency may become more intensive. Accordingly, the user may automatically check whether there is any response file through the wireless communication electronic device 40 to obtain the instruction execution state.

Besides periodically checking whether there is any file in the first input storage space 412, the wireless communication electronic device 40 may also download the file containing the home control instructions according to the notification from the cloud storage device 60 in the example where the cloud storage device 60 provides a notification with respect to the change of the file. For instance, in still another exemplary embodiment, the gateway management module 208 may also store the response files corresponding to the home control instructions in the first input storage space 412 configured for the wireless communication electronic device 40. And, when receiving a file change notification (i.e., a second file change notification) from the cloud storage device 60, the wireless communication electronic device 40 downloads a response file from the first input storage space 412 to obtain an instruction execution state in response to second file change notification.

With the implementations described above, in the invention, the storage space of the cloud storage device may be divided and configured based on the wireless communication electronic device and the home control gateway, the user may upload the file containing the home control instructions to the storage space configured for the home control gateway through the wireless communication electronic device and notify the home control gateway to download the file to execute the home control instructions contained in the file to conveniently manage the home control functions. Afterwards, the home control gateway may store the response files in the storage space configured for the wireless communication electronic device and notify the wireless communication electronic device to receive the response files, such that the execution performance may be easily obtained.

### Second Exemplary Embodiment

FIG. 5 is a schematic diagram illustrating a storage space according to the second exemplary embodiment of the invention. In the present exemplary embodiment, the user may instruct a plurality of home control gateways (e.g., a first home control gateway and a second home control gateway) through the wireless communication electronic device 40 to control the home equipment.

With reference to FIG. 5, the storage space 400 of the cloud storage device 60 is divided into a first input storage space 412 and a first output storage space 414 configured for the wireless communication electronic device 40, a second input storage space 522 and a second output storage space 524 configured for the first home control gateway, a third input storage space 532 and a third output storage space 534 configured for the second home control gateway, and the first home control gateway and the second home control gateway have the same or similar configuration and functions of the home control gateway illustrated in FIG. 2.

In the present exemplary embodiment, the user transmits the file containing the home control instructions to the first output storage space 414 configured for the wireless communication electronic device 4 through the wireless communication electronic device 40 to instruct the home control gateways to execute the home control instructions in the file.

Then, the user may call to the first home control gateway and the second home control gateway through the wireless communication electronic device 40 to notify the home control gateways to download the file from the first output storage space 414 configured for the wireless communication electronic device 40 in the cloud storage device 60 to execute the home control instruction contained in the file. The first and the second home control gateways may the incoming call signal from the wireless communication electronic device 40 through the second communication circuit 206 and identify the incoming phone number according to the incoming call signal. If the incoming phone number is identical to a pre-stored phone number stored in a gateway management module 208 of each of the first and the second home control gateways, the gateway management module 208 may download the file from the first output storage space 414.

Additionally, the user may also call to the first home control gateway, but not the second home control gateway. Thus, the first home control gateway receiving the incoming call signal may receive the file from the cloud storage device 60 and change a state of a home control switch according to a home control instruction. In contrast, the second home control gateway not receiving the incoming call signal is not operated. In this way, after the file containing the home control instructions is uploaded, the user may notify the home control gateways to download the file from the cloud storage device 60 by means of the mobile communication signal and change the states of the home control switches according to the home control instructions.

In the present exemplary embodiment, after each of the gateway management modules 208 downloads the file from the first output storage space 414 configured for the wireless communication electronic device 40 in the cloud storage device 60, each of the home control gateways may analyze the file to obtain the home control instructions and respectively execute the home control instructions contained in the file to change the states of the home control switches. To be specific, each home control gateway has a predetermined gateway number. For example, a predetermined gateway number of the first home control gateway may be gateway number 1, and a predetermined gateway number of the second home control gateway may be gateway number 2. When the home control gateway analyzes the file, the home control gateway may determine whether a gateway number corresponding to a home control instruction in the file is identical to the predetermined gateway number. When the gateway number corresponding to the home control instruction is identical to the predetermined gateway number of the home control gateway, the home control gateway executes the home control instruction corresponding to the gateway number which is identical to the its predetermined gateway number. Additionally, in case the gateway number corresponding to the home control instruction is different from the predetermined gateway number of the home control gateway, the home control gateway ignores (e.g., does not obtain or does not execute) the home control instruction corresponding to the gateway number different from its predetermined gateway number. For example, referring to FIG. 3, the first home control gateway may obtain and execute a home control instruction corresponding to a gateway number recorded in the instruction table 300 which is identical to the predetermined gateway number 1 of the first home control gateway, and the second home control gateway may obtain and execute a home control instruction corresponding to a gateway number recorded in the instruction table 300 which is identical to the predetermined gateway number 2 of the second home control gateway. Additionally, the home control gateway may store an execution result as a response file to report the execution performance to the user. The response file may contain an instruction execution state, such as whether the state of the home equipment is successfully changed and the settings after the change.

In the present exemplary embodiment, the gateway management module 208 of each of the first and the second home control gateways may store the response file corresponding to the home control instructions in second output storage space 524 configured for the first home control gateway and in the third storage space 534 configured for the second home control gateway in the cloud storage device 60.

Meanwhile, the gateway management module 208 of each of the first and the second home control gateways may transmit a signal to wireless communication electronic device 40 through the mobile phone network 50 by using the second communication circuit 206. The wireless communication electronic device 40 downloads the response file from the second output storage space 524 configured for the first home control gateway to obtain the instruction execution state of the first home control gateway according to the signal from the first home control gateway. And, the wireless communication electronic device 40 downloads the response file from the third output storage space 534 configured for the second home control gateway to obtain the instruction execution state of the second home control gateway according to the signal from the second.

It should be noted that the above exemplary embodiment may be used together with each implementation of the first exemplary embodiments or used alone, and the invention is not limited thereto.

With the implementations described above, in the invention, the storage space of the cloud storage device may be divided and configured based on the wireless communication electronic device and the home control gateways, the user may upload the file containing the home control instructions to the storage space configured for the wireless communication electronic device through the wireless communication electronic device and notify the home control gateways to download the file to execute the home control instructions contained in the file to conveniently manage the home control functions. Afterwards, the home control gateways store the response files in the storage space configured for the home control gateway and notify the wireless communication electronic device to receive the response files, such that the execution performance may be easily obtained.

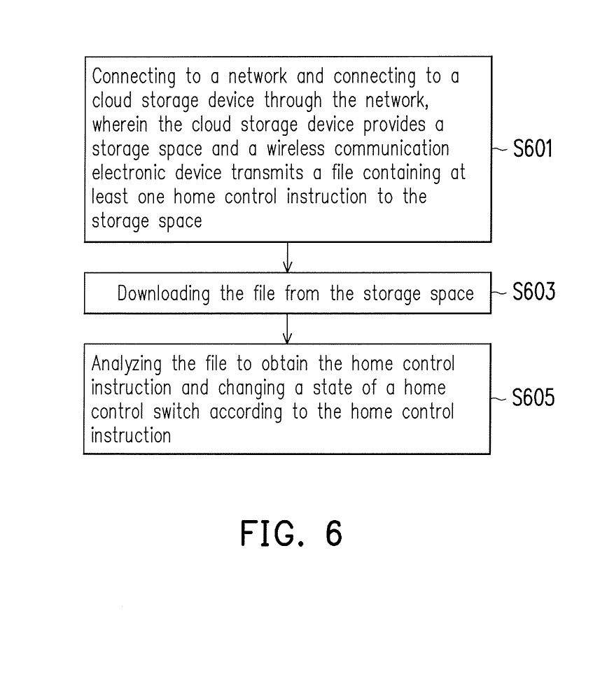

FIG. 6 is a flowchart illustrating a home control method according to an exemplary embodiment of the invention.

With reference to FIG. 6, in step S601, the home control gateway 20 is connected to a network (by using the first communication circuit 204) and connected to the cloud storage device 60 through the network. Therein, the cloud storage device 60 provides a storage space, and the wireless communication electronic device 40 transmits a file including at least one home control instruction to the storage space.

In step S603, the home control gateway 20 (the gateway management module 208) downloads the file from the storage space. And, in step S605, the home control gateway 20 (the gateway management module 208) analyzes the file to obtain a home control instruction and changes a state of a home control switch according to the home control instruction.

Each step of FIG. 6 has been described in detail above and thus, will not be repeated hereinafter. It should be noted that each step of FIG. 6 may be implemented as a plurality of program codes or circuits, which construes no limitations to the invention. Moreover, the method of FIG. 6 may also be used together with the exemplary embodiments or used alone, and the invention is not limited thereto.

To sum up, in the home control gateway and the home control method of the invention, the file containing the home control instructions which is stored in the cloud storage device by the wireless communication electronic device is downloaded and analyzed to obtain the home control instructions, and the states of the home control switches are changed according to the home control instructions, such that the home control function can be conveniently managed. Moreover, in the invention, according to the storage space of the cloud storage device divided and configured for the wireless communication electronic device and for the home control gateway, the user can use the wireless communication electronic device to upload the file containing the home control instructions to the storage space configured for the home control gateway and notify the home control gateway to download the file and execute the home control instructions contained in the file. In this way, the user can solely instruct the home control gateway to achieve conveniently managing the home control function, upload the response files to the storage space configured for the wireless communication electronic device by using the home control gateway and notify the wireless communication electronic device to download the file to obtain the instruction execution state for acquire the execution performance easily. In addition, in the invention, the user can also use the wireless communication electronic device to upload the file containing the home control instructions to the storage space configured for the wireless communication electronic device and notify the home control gateways to download the file and execute the home control instructions contained in the file. In this way, the user can instruct a plurality of home control gateways simultaneously to achieve conveniently managing the home control function, upload the response files to the storage space configured for the home control gateway by using the home control gateways and notify the wireless communication electronic device to download the file to obtain the instruction execution state for acquiring the execution performance easily.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A home control gateway, comprising:
a microprocessor unit;
a first communication circuit coupled to the microprocessor unit, wherein the first communication circuit connects to a network and connects to a cloud storage device through the network, wherein the cloud storage device provides a storage space, a wireless communication electronic device transmits a file to the storage space, and the file comprises at least one home control instruction;
a second communication circuit coupled to the microprocessor unit, wherein the second communication circuit connects to a mobile phone network; and
a gateway management module coupled to the microprocessor unit,
wherein the gateway management module downloads the file from the storage space, analyzes the file to obtain the at least one home control instruction and changes a status of a home control switch according to the at least one home control instruction.

2. The home control gateway according to claim 1, wherein the storage space is divided into at least a first input storage space and a first output storage space configured for the wireless communication electronic device, and the wireless communication electronic device transmits the file to the first output storage space, wherein the second communication circuit receives an incoming call signal from the wireless communication electronic device and identifies an incoming phone number according to the incoming call signal,
wherein if the incoming phone number is identical to a pre-stored phone number stored in the gateway management module, the gateway management module downloads the file from the first output storage space.

3. The home control gateway according to claim 1, wherein the storage space is divided into at least a second input storage space and a second output storage space configured for the gateway management module, and the wireless communication electronic device transmits the file to the second output storage space,
wherein the gateway management module checks whether there is any file in the second input storage space per a first predetermined time period,
wherein if the file is in the second input storage space, the gateway management module downloads the file from the second input storage space.

4. The home control gateway according to claim 1, wherein the storage space is divided into at least a second input storage space and a second output storage space configured for the gateway management module, and the wireless communication electronic device transmits the file to the second output storage space,
wherein the first communication circuit receives a first file change notification from the cloud storage device, and the gateway management module downloads the file from the second input storage space in response to the first file change notification.

5. The home control gateway according to claim 1, wherein the storage space is divided into at least a second input storage space and a second output storage space configured for the gateway management module, and the wireless communication electronic device transmits the file to the second output storage space,
wherein the second communication circuit receives an incoming call signal from the wireless communication electronic device and identifies an incoming phone number according to the incoming call signal,
wherein if the incoming phone number is identical to a pre-stored phone number stored in the gateway management module, the gateway management module downloads the file from the second input storage space.

6. The home control gateway according to claim 2,
wherein the gateway management module stores at least one response file corresponding to the at least one home control instruction in the second output storage space, and the at least one response file comprises an instruction execution state,
wherein the gateway management module transmits a signal to the wireless communication electronic device through the mobile phone network by using the second communication circuit,
wherein the wireless communication electronic device downloads the at least one response file from the second output storage space according to the signal to obtain the instruction execution state.

7. The home control gateway according to claim 2, wherein the gateway management module stores at least one response file corresponding to the at least one home control instruction in the first input storage space, and the at least one response file comprises an instruction execution state,
wherein the gateway management module transmits a signal to the wireless communication electronic device through the mobile phone network by using the second communication circuit,
wherein the wireless communication electronic device downloads the at least one response file from the first input storage space according to the signal to obtain the instruction execution state.

8. The home control gateway according to claim 2, wherein the gateway management module stores at least one response file corresponding to the at least one home control instruction in the first input storage space, and the at least one response file comprises an instruction execution state,
wherein the wireless communication electronic device checks whether there is any response file in the first input storage space per a second predetermined time period,
wherein if the at least one response file is in the first input storage space, the wireless communication electronic device downloads the at least one response file from the first input storage space to obtain the instruction execution state.

9. The home control gateway according to claim 2, wherein the gateway management module stores at least one response file corresponding to the at least one home control instruction in the first input storage space, and the at least one response file comprises an instruction execution state,
wherein the wireless communication electronic device receives a second file change notification from the cloud storage device and downloads the at least one response file from the first input storage space to obtain the instruction execution state in response to the second file change notification.

10. The home control gateway according to claim 2, wherein the incoming call signal is a voice communication signal or a short message service (SMS) signal.

11. The home control gateway according to claim 6, wherein the signal transmitted from the gateway management module through the mobile phone network by using the second communication circuit is a voice communication signal or an SMS signal.

12. The home control gateway according to claim 1, wherein the file comprises a gateway number, a function number and an operation instruction.

13. A home control method for a home control gateway, the home control method comprising:
connecting to a network and connecting to a cloud storage device through the network, wherein the cloud storage device provides a storage space, a wireless communication electronic device transmits a file to the storage space, and the file comprises at least one home control instruction;
downloading the file from the storage space; and
analyzing the file to obtain the at least one home control instruction and changing a state of a home control switch according to the at least one home control instruction.

14. The home control method according to claim 13, further comprising:
connecting to a mobile phone network,
wherein the storage space is divided into at least a first input storage space and a first output storage space configured for the wireless communication electronic device, and the wireless communication electronic device transmits the file to the first output storage space,
wherein the step of downloading the file from the storage space comprises:
receiving an incoming call signal from the wireless communication electronic device through the mobile phone network and identifying an incoming phone number according to the incoming call signal; and
if the incoming phone number is identical to a pre-stored phone number, downloading the file from the first output storage space.

15. The home control method according to claim 13, wherein the storage space is divided into at least a second input storage space and a second output storage space configured for the home control gateway, and the wireless communication electronic device transmits the file to the second output storage space,
wherein the step of downloading the file from the storage space comprises:
checking whether there is any file in the second input storage space per a first predetermined time period; and
if the file is in the second input storage space, downloading the file from the second input storage space.

16. The home control method according to claim 13, wherein the storage space is divided into at least a second input storage space and a second output storage space configured for the home control gateway, and the wireless communication electronic device transmits the file to the second output storage space,
wherein the step of downloading the file from the storage space comprises:
receiving a first file change notification from the cloud storage device and downloading the file from the second input storage space in response to the first file change notification.

17. The home control method according to claim 13, further comprising:
connecting to a mobile phone network,
wherein the storage space is divided into at least a second input storage space and a second output storage space configured for the home control gateway, and the wireless communication electronic device transmits the file to the second output storage space,
wherein the step of downloading the file from the storage space comprises:
receiving an incoming call signal from the wireless communication electronic device through the mobile phone network and identifying an incoming phone number according to the incoming call signal; and
if the incoming phone number is identical to a pre-stored phone number, downloading the file from the second input storage space.

18. The home control method according to claim 14, further comprising:
storing at least one response file corresponding to the at least one home control instruction in the second output storage space, wherein the at least one response file comprises an instruction execution state; and
transmitting a signal to the wireless communication electronic device through the mobile phone network, wherein the wireless communication electronic device downloads the at least one response file from the second output storage space according to the signal to obtain the instruction execution state.

19. The home control method according to claim 14, further comprising:
storing at least one response file corresponding to the at least one home control instruction in the first input storage space, wherein the at least one response file comprises an instruction execution state; and
transmitting a signal to the wireless communication electronic device through the mobile phone network, wherein the wireless communication electronic device downloads the at least one response file from the first input storage space according to the signal to obtain the instruction execution state.

20. The home control method according to claim 14, further comprising:
storing at least one response file corresponding to the at least one home control instruction in the first input storage space, wherein the at least one response file comprises an instruction execution state;
checking whether there is any response file in the first input storage space per a second predetermined time period by the wireless communication electronic device; and
if the at least one response file is in the first input storage space, downloading the response file from the first input storage space to obtain the instruction execution state by the wireless communication electronic device.

21. The home control method according to claim 14, further comprising:
storing at least one response file corresponding to the at least one home control instruction in the first input storage space, wherein the at least one response file comprises an instruction execution state; and
receiving a second file change notification from the cloud storage device and downloading the at least one response file from the first input storage space to obtain the instruction execution state in response to the second file change notification by the wireless communication electronic device.

22. The home control method according to claim 14, wherein the incoming call signal is a voice communication signal or an SMS signal.

23. The home control method according to claim 18, wherein the signal transmitted through the mobile phone network is a voice communication signal or an SMS signal.

24. The home control method according to claim 13, wherein the file comprises a gateway number, a function number and an operation instruction.
